(19) United States
(12) Patent Application Publication
(10) Pub. No.: US 2007/0002826 A1
(43) Pub. Date: Jan. 4, 2007

(54) System implementing shared interface for network link aggregation and system management

(76) Inventors: Matthew J. Bennett, Austin, TX (US); Hendrich M. Hernandez, Round Rock, TX (US)

Correspondence Address: Richard D. Egan;O'KEEFE, EGAN & PETERMAN, Building C, Suite 200, 1101 Capital of Texas Highway South, Austin, TX, 78746, US

(21) Appl. No.: 11/170,372

(22) Filed: Jun. 29, 2005

(51) Int. Cl. H04L 12/28; H04L 12/66

(52) U.S. Cl. 370/351; 370/463

(57) ABSTRACT

A technique is disclosed for combining link aggregation techniques and system management techniques. More particularly, system management techniques may share ports with the link aggregation team ports. The link aggregation team may include one or more ports that connect to a device that is connected to a baseboard management controller. The ports that connect to the baseboard management controller may be configured as a sub-team within the link aggregation team. The sub-team may be mapped to a dedicated MAC address. System management packets may be selectively routed to this sub-team of ports.

### TECHNICAL FIELD OF THE INVENTION

This invention relates to systems that utilize network link aggregation and system management interfaces and, more particularly, to systems that have a shared interface for link aggregation and management traffic.

### BACKGROUND

Computing systems often include network interfaces. These interfaces often include wired network interfaces and wireless network interfaces for communicating with hardwired or wireless networks respectively. A well known wired network standard is the Ethernet standard. In order to improve the reliability and bandwidth of a network interface, a plurality of network interfaces may be implemented within a system to communicate with a network. For example, the EtherChannel and IEEE 802.3ad standards are network link aggregation standards that allow several Ethernet network interfaces (for example Ethernet Network Interface Cards (NICs) or Ethernet LAN on Motherboard (LOM) devices) to be aggregated together to form a single pseudo interface for communicating between the system and the network. Such techniques may also be known as “teaming” or “trunking”. In addition to increasing the bandwidth available by utilizing multiple network interfaces (as opposed to one), the reliability of systems utilizing aggregating techniques may be improved by providing redundant network connections such that the failure of a single network connection does not disable the system. A wide variety of types of link aggregation techniques are known, including for example switch dependent techniques such as EtherChannel and IEEEE 802.3ad and also including, for example, switch independent techniques such as the Broadcom Smart Load Balance (SLB) and Intel Adaptive Load Balancing (ALB).

Systems that utilize network link aggregation often may also utilize system management techniques. A wide range of system management applications, standards and techniques are widely known. For example, The Intelligent Platform Management Interface (IPMI) is a specification that is often utilized in server environments for remote server management. The IPMI specification defines system, network, and board level interfaces to a management controller called the Baseboard Management Controller (BMC). For example, the IPMI specification provides management for basic hardware management, power management, event logging, event handling, sensor readings, BIOS, alternative boot, etc. The IPMI specification is just one example of many system management applications, standards or specifications. For example, other system management techniques include the Simple Network Management Protocol (SNMP), RMCP (an enhanced protocol for delivering IPMI payloads over IP), Alert Standard Format (ASF), Remote Monitoring (RMON) and Common Information Model (CIM).

An exemplary prior art system utilizing both network link aggregating and a remote system management interface is shown in FIG. 1. As shown in FIG. 1, a hardware system 100 (such as for example a server) may include multiple LOM devices 110 and multiple NIC devices 120 that communicate with a network through ports (or links) 112. Link aggregation techniques (for example according to the IEEE 802.3ad standard) may be utilized to aggregate the ports 112. The aggregated ports 112 may be called a team. The LOM devices 110 and NIC devices 120 may be connected to a system bus 140 that communicates with other system resources 150 (such as for example typical server resources). Remote system management protocols may be utilized in conjunction with a BMC 160. BMC may be connected for remote system management through a dedicated management port (or link) 170. In such a system all traffic destined for the BMC comes in a specific port, for example port 170.

The devices that may include network link aggregating and remote system management techniques are wide ranging. For example, as the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

### SUMMARY OF THE INVENTION

A method and system are disclosed for combining link aggregation techniques and system management techniques. More particularly, system management techniques may share ports with the link aggregation team ports. The link aggregation team may include one or more ports that connect to a device that is connected to a baseboard management controller. The ports that connect to the baseboard management controller may be configured as a sub-team within the link aggregation team. The sub-team may be mapped to a dedicated MAC address. System management packets may be selectively routed to this sub-team of ports.

In another embodiment, a method for routing network communication traffic is provided. The method may comprise aggregating a plurality of system ports into a primary link aggregation team and assigning a management sub-team to include at least one system port, the at least one system port being a part of the primary link aggregation team. The method further comprises directing at least some remote system management communication traffic selectively to the management sub-team while allowing the at least one system port of the management sub-team to also receive operating system related communication traffic.

In still another embodiment, a method for providing system management communication to or from a system management controller is disclosed. The method may comprise assigning a plurality of network interfaces to a link aggregation team for communication of non-system management data and assigning at least one network interface as at least one remote management network interface, wherein the at least one management network interface is a member of the link aggregation team. The method may further comprise selectively providing system management data to the at least one remote management network interface and providing non-system management data to the remote management network interface as a member of the link aggregation team, wherein the remote management network interface is a shared network interface.

In yet another embodiment, an information handling system is disclosed. The information handling system may comprise at least one system management controller and a plurality of network interface ports coupled to system resources of the information handling system. The system may further comprise a primary link aggregation team comprised of at least a portion of the plurality of network interface parts. The system further includes a first subset of the network interface ports coupled to the at least one system management controller and a link aggregation sub-team comprised of the first subset of the network interface ports to form a sub-team of the primary aggregation team. The primary link aggregation team, including the link aggregation sub-team, may communicate operating system functionality related data and the link aggregation sub-team preferentially communicates at least some remote system management related data.

### DESCRIPTION OF THE DRAWINGS

It is noted that the appended drawings illustrate only exemplary embodiments of the invention and are, therefore, not to be considered limiting of its scope, for the invention may admit to other equally effective embodiments.

FIG. 1 illustrates an exemplary prior art system having network link aggregating and remote system management.

FIG. 2 is an exemplary system utilizing network link aggregating and remote system management techniques utilizing shared ports.

FIG. 3 illustrates an exemplary technique for allocating MAC addresses for the system of FIG. 2.

### DETAILED DESCRIPTION OF THE INVENTION

As described in more detail below, a technique is disclosed herein for combining link aggregation techniques and system management techniques. More particularly, system management techniques may share ports with the link aggregation team ports rather than utilizing a dedicated system management port. The link aggregation team may include one or more ports that connect to a device that is connected to the BMC. The ports that connect to the BMC may be configured as a sub-team within the link aggregation team. System management packets may be selectively routed to the specific sub-team of ports that is connected to the BMC.

It will be recognized that the structures, techniques and methods described herein may be utilized in conjunction with a wide variety of systems and devices, including for example information handling systems. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, finctionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

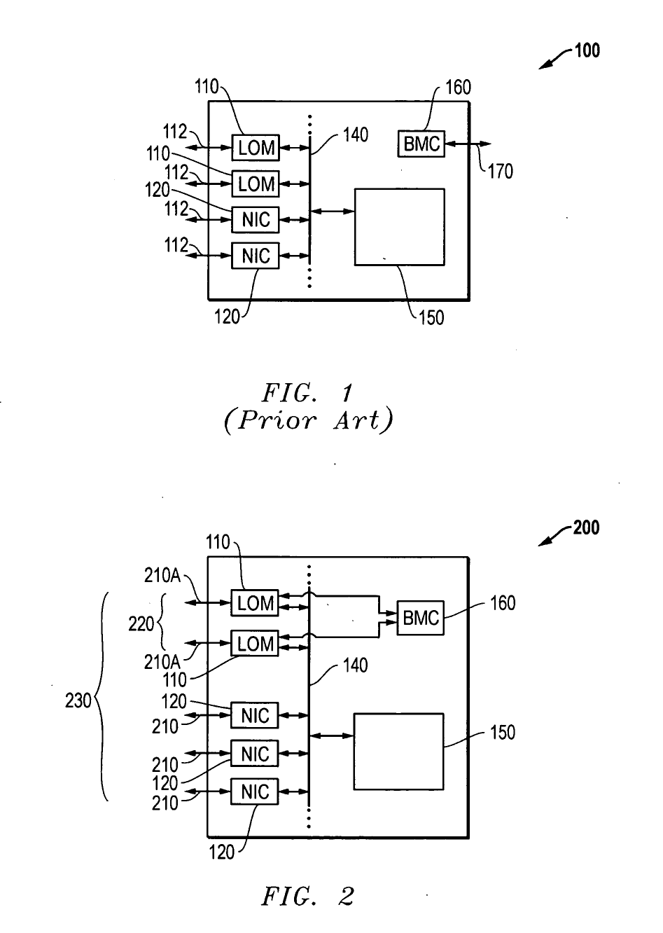

FIG. 2 illustrates an exemplary information handling system 200 that may utilize the network link aggregating and remote system management techniques utilizing shared ports that are described herein. As shown in FIG. 2, the information handling system 200 (such as, for example, a server) may include multiple LOM devices 110 and multiple NIC devices 120 that communicate with a network through ports (or links) 210A and 210 respectively as shown. For example, the ports 210 and 210A may communicate with a network switch or other devices of a network. Link aggregation techniques may be utilized to aggregate the ports 210 and 210A as described in more detail. The LOM devices 110 and NIC devices 120 may be connected to a system bus 140 that communicates with other system resources 150 (such as for example typical server resources). Remote system management protocols may be utilized in conjunction with a BMC 160. BMC may be connected for remote system management through ports 210A and LOM devices 110. In this regard, LOM devices 110 are connected both to the system bus 140 and to the BMC 160. The system management frames destined to or from the BMC 160 are thus provided over ports 210A. Ports 210A therefore are shared ports that process frames destined for both (1) system management function of the BMC 160 and (2) operating system (OS) functions of the information handling system 200 that are performed in conjunction with the system bus 140 and the system resources 150. The connection to the BMC 160 from the LOM devices 110 may be transparent from the perspective of the OS which is not required to be aware of communications with the BMC 160. Alternatively, the communication between the LOM devices 110 and the BMC 160 need not be a separate dedicated link and system resources such as the system bus may be utilized. The BMC 160 may perform remote management function according to the IPMI specification. It will be recognized however that other management specifications, protocols and standards may be used instead of the IPMI specification and that the techniques described herein are not limited to a specific system management specification, protocol or standard.

The sharing of selective ports of the link aggregation team may be accomplished by creating a sub-team within the link aggregation team. More particularly, with regard to FIG. 2 ports 210 and 210A may be aggregated together to form the primary OS team 230. OS related functions may be routed to and from any of the ports 210 and 210A of the primary OS team 230. System management functions of the BMC may however be routed to and from a selective subset of the primary team, in particular a management sub-team 220 comprised of ports 210A. The management sub-team 220 is comprised of ports that are connected to the BMC 160. The example shown in FIG. 2 illustrates two LOM devices 110 connected to the BMC 160, however, it will be recognized that this is merely illustrative and other configurations may be utilized. For example, other numbers of devices may be utilized and other numbers of devices may be connected to the BMC 160 and/or connected to the system bus 140. Furthermore, though the network interface devices shown in FIG. 2 connected to the BMC 160 are only LOM devices, other network interface devices, such as for example, NICs may be connected to the BMC. Further, the network interface devices utilized for the primary OS team and for the management sub-team need not be limited to hardwired network interfaces and wireless interfaces may also be utilized as all or some of either the primary team or the sub-team. Thus, it will be recognized that the examples shown herein are merely illustrative and techniques and systems disclosed herein may have many different possible implementations while still taking advantage of the inventive concepts disclosed herein.

For outgoing traffic from the BMC 160 the ports 210A will be utilized. The information handling system 200 may utilize load balancing techniques between the ports 210 and 210A to most effectively provide both system management and OS functions. For incoming traffic, system management traffic will be routed by the network to ports 210A and OS related traffic may be routed to any of the primary team 230 ports. Thus, it is desirable for the network to which the information handling system 200 is coupled to have knowledge of which ports are included in the primary and management teams. For example, if the ports are coupled to a network switch it is desirable for the switch to be capable of routing system management traffic (such as for example management frames) to the ports 210A.

One technique for implementing the proper incoming routing of traffic between the management sub-team ports and the OS team ports is to assign media address control (MAC) addresses to the management sub-team and the primary team that are different (as is well known, a MAC address is a layer 2 data link address of the Open System Interconnection (OSI) model). Therefore, frames destined for management function are only routed to the ports in the management sub-team and OS related frames are routed to any of the primary team ports.

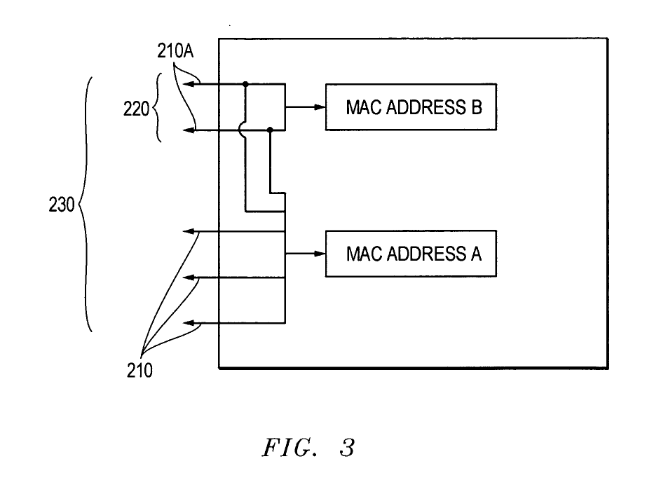

In a typical link aggregation protocol all the network interface ports that form a team that is aggregated are typically assigned the same common MAC address so that they are treated by remote systems as if they were one network interface device. Though remote systems view such teams as a one network interface, a network device (such as a switch, gateway or router for example) then may route or distribute traffic destined for the common MAC address to various ports of the team. Link aggregation techniques may be modified to support the different MAC addresses provided to a management sub-team and the primary OS team. FIG. 3 illustrates an exemplary technique for implementing the traffic routing between the management sub-team and the primary team utilizing MAC addresses. In particular, as shown in FIG. 3 ports 210 which provide only OS function traffic are mapped only to MAC address A. Ports 210A which form the management sub-team ports 220 are mapped to both MAC address B and MAC address A. In operation, the link protocol in a network device such as a network switch or network router checks the frame header for the destination MAC address. If the destination MAC address is address A (OS related frames) then the frame would be load balanced across any of ports 210 and 210A. If the destination MAC address is address B (management related frames), then the frame would be load balanced across only ports 210A. Such a technique will therefore allow load balancing traffic in both directions of the communication path.

In this manner, network traffic that is related to OS operations can be load balanced across all the network interface ports while still allowing network traffic that is system management related to be routed to the select network interfaces that are connected to the system management resources such as a system management controller. In one embodiment the link aggregation protocol may be similar to the IEEE 802.3ad protocol. In such an embodiment, the IEEE 802.3ad protocol may be modified to further contemplate a management sub-team within the primary link aggregation team. A separate MAC addresses may be assigned such as shown in FIG. 3 so that at least one sub-team port is affiliated with a plurality of MAC addresses. Other link aggregation techniques, specifications, protocols and standards, may however be utilized and the concepts disclosed herein are not limited to any specific link aggregation techniques, specifications, protocols and standards.

It will be recognized that the utilization of a separate management sub-team MAC address is just one approach for implementing a separate management sub-team within a link aggregation primary team. Other techniques and protocols may be utilized to achieve the desired result of providing system management traffic to and from a management sub-team while still allowing the sub-team ports to be utilized as part of the primary team aggregation. For example, segregation of the management traffic may be accomplished by UDP or TCP port segregation. In such a case decisions may be made based upon a port identifier (such as for example a TCP port number). In such a case all traffic destined for the BMC would be directed to a particular port number. The network device that the system 100 may be connected to in such a case may be a router or gateway or network switch that has added port identification capabilities.

It will be noted that some of the disclosure above contemplated that the information handling system 100 was construed as a networked end device such as a server and the information handling system 100 was contemplated being coupled to a network distribution device such as a network switch, router, gateway, etc. However, the techniques disclosed herein may also be implemented wherein the information handling system 100 may itself be a network distribution device such as a network switch, router, gateway, etc. As described above, it will be recognized that an information handling system may include a wide range of systems and device.

Further modifications and alternative embodiments of this invention will be apparent to those skilled in the art in view of this description. It will be recognized, therefore, that the present invention is not limited by these example arrangements. Accordingly, this description is to be construed as illustrative only and is for the purpose of teaching those skilled in the art the manner of carrying out the invention. It is to be understood that the forms of the invention herein shown and described are to be taken as the presently preferred embodiments. Various changes may be made in the implementations and architectures. For example, equivalent elements may be substituted for those illustrated and described herein, and certain features of the invention may be utilized independently of the use of other features, all as would be apparent to one skilled in the art after having the benefit of this description of the invention. For example, the various communication protocols described herein (such as 802.11a/b/g/n, UWB, cellular, etc.) are merely exemplary and it will be recognized that other current and future standards may equally utilized the techniques described herein. Furthermore, the prioritization classes described herein are merely exemplary and other classes of traffic and/or other levels of priority may be utilized while still providing the benefits of the concepts disclosed herein.

What is claimed is:

1. A method for routing network communication traffic, comprising:
aggregating a plurality of system ports into a primary link aggregation team;
assigning a management sub-team to include at least one system port, the at least one system port being a part of the primary link aggregation team; and
directing at least some remote system management communication traffic selectively to the management sub-team while allowing the at least one system port of the management sub-team to also receive operating system related network communication traffic.

2. The method of claim 1, wherein the management sub-team includes a plurality of system ports.

3. The method of claim 1, wherein a management sub-team MAC address is assigned distinct from a primary link aggregation team MAC address.

4. The method of claim 3, wherein a network distribution device utilizes the method.

5. The method of claim 3, wherein a server utilizes the method.

6. The method of claim 1, wherein at least one management sub-team system port is coupled to a LOM device.

7. A method for providing system management communication to or from a system management controller, comprising:
assigning a plurality of network interfaces to a link aggregation team for communication of non-system management data;
assigning at least one of the plurality of network interface as at least one remote management network interface, wherein the at least one remote management network interface is a member of the link aggregation team;
selectively providing system management data to the at least one remote management network interface; and
providing non-system management data to the remote management network interface as a member of the link aggregation team,
wherein the remote management network interface is a shared network interface.

8. The method of claim 7, wherein the system management controller is a baseboard management controller.

9. The method of claim 8, wherein the system management communication is compliant with the IPMI specification.

10. The method of claim 7, wherein the link aggregation team is assigned a first MAC address and the remote management network interface is assigned a second MAC address, the remote management network interface receiving at least some communication directed to the first MAC address and at least some communication directed to the second MAC Address.

11. The method of claim 10, wherein the at least one remote management network interface comprises a plurality of remote management network interfaces that form a sub-team within the link aggregation team.

12. An information handling system, comprising:
at least one system management controller;
a plurality of network interface ports coupled to system resources of the information handling system;
a primary link aggregation team comprised of at least a portion of the plurality of network interface parts;
a first subset of the network interface ports coupled to the at least one system management controller; and
a link aggregation sub-team comprised of the first subset of the network interface ports to form a sub-team of the primary aggregation team,
wherein the primary link aggregation team, including the link aggregation sub-team, communicates operating system finctionality related data and the link aggregation sub-team preferentially communicates at least some remote system management related data.

13. The information handling system of claim 12, wherein the link aggregation sub-team comprises a plurality of network interface ports.

14. The information handling system of claim 12, wherein the first subset of the network interface ports is coupled to at least one LOM device.

15. The information handling system of claim 14, wherein the at least one LOM device is coupled to both a system bus and the at least one system management controller.

16. The information handling system of claim 15, wherein the primary link aggregation team has a first MAC address and the link aggregation sub-team has a second MAC address, the link aggregation sub-team configured to receive data corresponding to both the first MAC address and the second MAC address.

17. The information handling system of claim 16, wherein the plurality of network interface ports are coupled to a plurality of NIC devices and the first subset of the network interface ports are coupled to a plurality of LOM devices.

18. The information handling system of claim 17, wherein a plurality of the LOM devices are coupled to both the system bus and the at least one system management controller.

19. The information handling system of claim 12, wherein the primary link aggregation team has a first MAC address and the link aggregation sub-team has a second MAC address, the link aggregation sub-team configured to receive data corresponding to both the first MAC address and the second MAC address.

20. The information handling system of claim 12, wherein the at least one system management controller is a remote management system management controller.
